(19) United States
(12) Patent Application Publication
(10) Pub. No.: US 2014/0169208 A1
(43) Pub. Date: Jun. 19, 2014

(54) DEMODULATION REFERENCE SIGNAL BASED CHANNEL STATE INFORMATION FEEDBACK IN OFDM-MIMO SYSTEMS

(71) Applicant: InterDigital Patent Holdings, Inc., Wilmington, DE (US)

(72) Inventors: Yingxue K. LI, San Diego, CA (US); Hongsan SHENG, San Diego, CA (US); Guodong ZHANG, Syosset, NY (US); Philip J. PIETRASKI, Jericho, NY (US)

(73) Assignee: InterDigital Patent Holdings, Inc., Wilmington, DE (US)

(21) Appl. No.: 14/188,233

(22) Filed: Feb. 24, 2014

Related U.S. Application Data
(63) Continuation of application No. 13/169,529, filed on Jun. 27, 2011.
(60) Provisional application No. 61/359,605, filed on Jun. 29, 2010.
(60) Provisional application No. 61/421,116, filed on Dec. 8, 2010.

(51) Int. Cl. H04L 25/02; H04L 5/00

(52) U.S. Cl. CPC H04L 25/0226; H04L 5/005
USPC 370/252

(57) ABSTRACT

A method and apparatus for using demodulation reference signal (DM-RS) based channel state information (CSI) feedback in Orthogonal Frequency Division Multiplexing-multiple-input multiple-output (OFDM-MIMO) systems is disclosed. The wireless transmit/receive unit (WTRU) receives one or more resource blocks from a base station, wherein the resource blocks (RBs) include demodulating reference signals (DM-RS) and precoder information. The precoder information is sent unicast or broadcasted over a common control channel. The WTRU estimates an effective channel estimate based on the DM-RS, derives an unprecoded channel based on the effective channel and the precoder information, generates CSI feedback based on the unprecoded channel, and transmits the CSI feedback to the base station. Alternatively, the WTRU estimates an effective channel estimate based on the DM-RS, quantizes the effective channel estimate and transmits the CSI feedback to the base station.

### CROSS REFERENCE TO RELATED APPLICATIONS

This application is a continuation of U.S. non-provisional application Ser. No. 13/169,529 filed on Jun. 27, 2011, which claims the benefit of U.S. Provisional Patent Application Nos. 61/359,605, filed on Jun. 29, 2010, and 61/421,116, filed on Dec. 8, 2010, the contents of each of which are hereby incorporated by reference herein.

### TECHNICAL FIELD

This disclosed subject matter relates to wireless communications.

### BACKGROUND

Orthogonal Frequency Division Multiplex (OFDM) is a multicarrier modulation scheme, where a data stream is transmitted using a number of multiplexed subcarriers. In OFDM multiple-input multiple-output (OFDM-MIMO) technology, multiple antennas are used to communicate OFDM data. According to some approaches to OFDM-MIMO, a wireless transmit/receive unit (WTRU) that is in communication with a base station may provide channel state information (CSI) to the base station to indicate properties of the air-link between the WTRU and the base station. In other approaches to OFDM-MIMO, a WTRU may provide CSI to a base station based on unprecoded channel state information reference signals (CSI-RS). While improvements have been made in recent years over previous approaches to the communication of CSI, further improvements to the generation, processing, and/or communication of CSI (such as but not limited to improvements that enhance the accuracy of CSI), may be needed.

### SUMMARY

A method and apparatus for using demodulation reference signal (DM-RS) based channel state information (CSI) feedback in Orthogonal Frequency Division Multiplexing-multiple-input multiple-output (OFDM-MIMO) systems are disclosed. The wireless transmit/receive unit (WTRU) receives one or more resource blocks from a base station, where the resource blocks (RBs) include demodulating reference signals (DM-RS) and precoder information. The precoder information is sent unicast or broadcast over a common control channel. The WTRU estimates an effective channel estimate based on the DM-RS, derives an unprecoded channel based on the effective channel and the precoder information, generates CSI feedback based on the unprecoded channel, and transmits the CSI feedback to the base station. Alternatively, the WTRU estimates an effective channel estimate based on the DM-RS, quantizes the effective channel estimate and transmits the CSI feedback to the base station.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is an example of the channel state information feedback based on an unprecoded channel;

FIG. 3 is an example of a method to feedback an effective channel; and

FIG. 4 shows a performance comparison between an example scheme and existing schemes.

### DETAILED DESCRIPTION

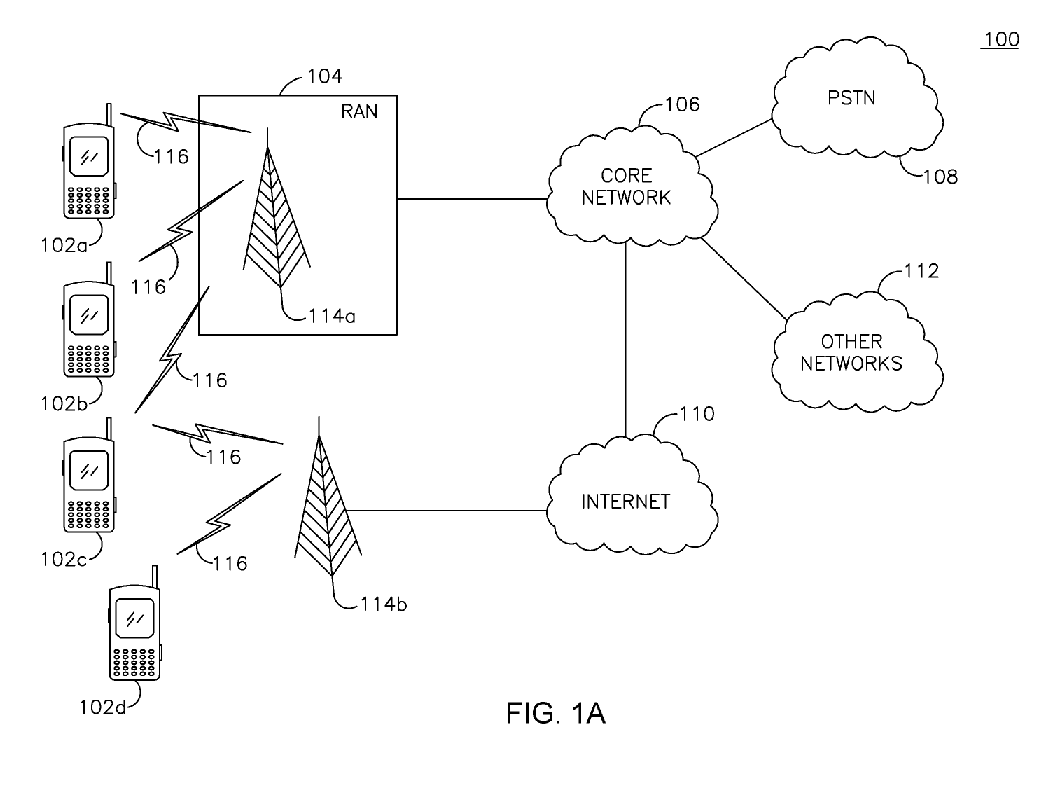

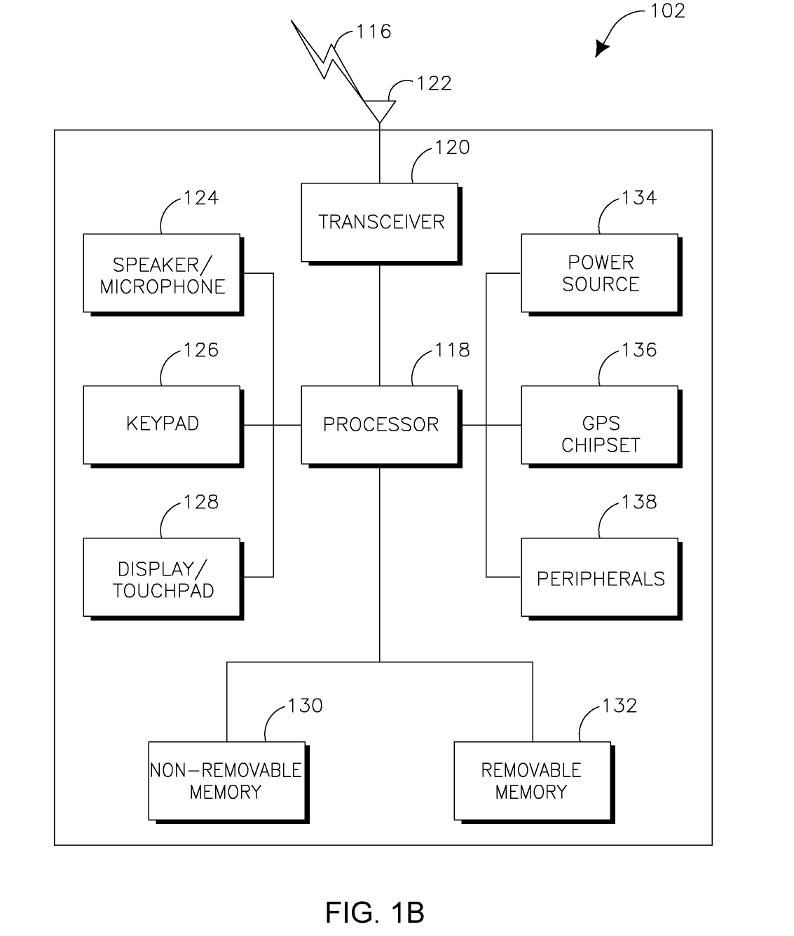

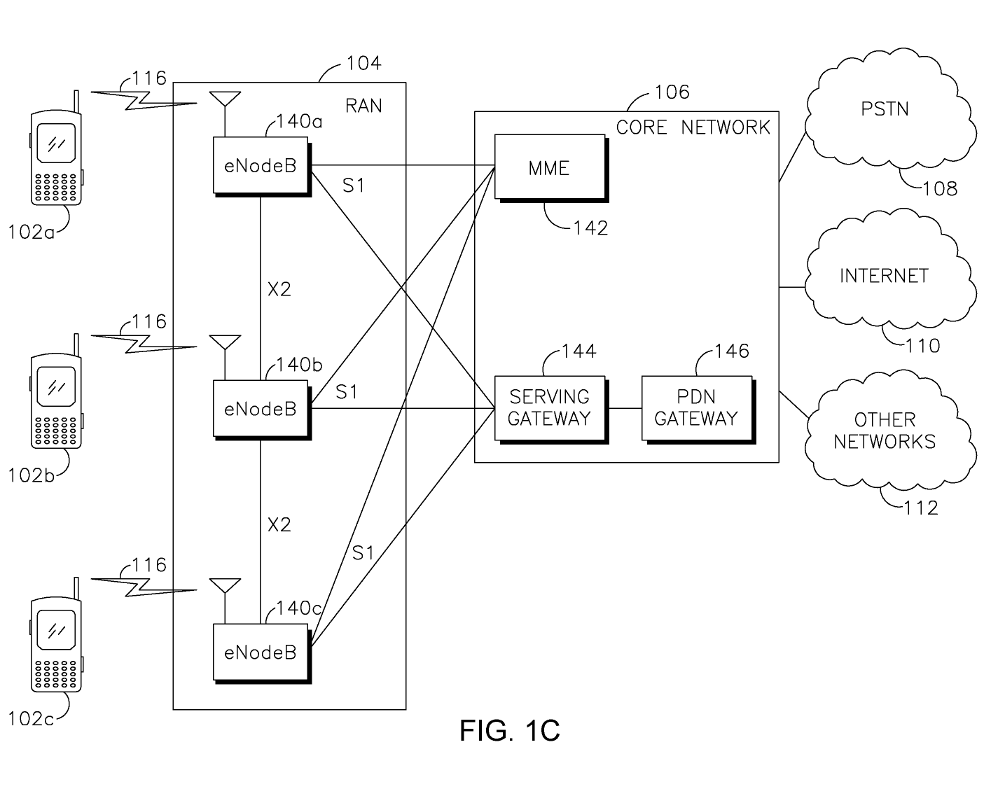

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B (nodeB), an eNode B (eNodeB) or (eNB), a Home Node B (HNB), a Home eNode B (HeNB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, and 102c over the air interface 116. The RAN 104 may also be in communication with the core network 106.

The RAN 104 may include eNodeBs 140a, 140b, 140c, though it will be appreciated that the RAN 104 may include any number of eNBs while remaining consistent with an embodiment. The eNBs 140a, 140b, 140c may each include one or more transceivers for communicating with the WTRUs 102a, 102b, 102c over the air interface 116. In one embodiment, the eNBs 140a, 140b, 140c may implement MIMO technology. Thus, the eNB 140a, for example, may use multiple antennas to transmit wireless signals to, and receive wireless signals from, the WTRU 102a.

Each of the eNBs 140a, 140b, and 140c may be associated with a particular cell (not shown) and may be configured to handle radio resource management decisions, handover decisions, scheduling of users in the uplink and/or downlink, and the like. As shown in FIG. 1C, the eNBs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNBs 142a, 142b, and 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

The eNBs 140a, 140b, 140c and the WTRUs 102a, 102b, 102c may communicate a number of different types of downlink signaling in order to provide feedback on the quality, reliability, and throughout of the communication that takes place over the air interface 116. The control information may include channel state information reference signal (CSI-RS) information, demodulation reference signal (DM-RS) information, information related to precoding matrices, and/or other types of information. Examples of this downlink signaling will be provided in detail below with reference to eNB 140a and WTRU 102a, though this information may be communicated by any or any combination of the eNBs 140a, 140b, 140c and the WTRUs 102a, 102b, 102c shown in FIG. 1C.

Downlink signaling communicated from the eNB 140a to the WTRU 102a includes DM-RS information and the WTRU 102a may perform channel quality measurements using the DM-RS information. Performing the channel quality measurements may include estimating the non-precoded channel to which the DM-RS information relates, measuring the effective channel, and generating corresponding CSI feedback information. The WTRU 102a may then transmit the CSI feedback information to the eNB 140a.

In an example where the downlink signaling from the eNB 140a to the WTRU 102a may include information related to precoding matrices, the eNB 140a may broadcast precoding matrices during transmission time interval (TTI) periods. The information included in the broadcast may have been previously used in the prior N TTIs, where the value for N may be a design parameter, or may be presently used in a current TTI, or may pertain to future TTIs. Alternatively or additionally, information included in the broadcast may include one or more of a transmitted precoding matrix indicator (TPMI) parameter, a parameter that indicates a transmission rank M, or a parameter that indicates a scrambling identity (ScID). As one example, a value for ScID may be of 1-bit length for transmission on an antenna port 7 or 8. When operating, for example, in LTE Release 9, multi-user multiple input multiple output system (MU-MIMO) mode; the eNB may send data and DM-RS on either antenna 7 or 8. The value of ScID may indicate whether antenna port 7 or 8 may be used for transmission.

In an example where the downlink signaling includes a TPMI parameter, the eNB 140 a may schedule the frequency of the transmission of the TPMI parameter in a number of different ways. As one example, the eNB 140a may schedule (and correspondingly broadcast) in terms of TTIs. In some instances, the eNB 140a may use a sparse broadcast of the TPMI (i.e., broadcasting every K TTIs), and in other instances, the eNB 140a may use a more frequent broadcast of the TPMI. Alternatively or additionally, the eNB 140a may schedule (and correspondingly broadcast) the TPMI on several RBs (associated with resource block bundling). Resource block bundling reduces the amount of overhead associated with TPMI broadcasting. A resource block may be defined as 7 or 6 consecutive OFDM symbols in the time domain depending on the cyclic prefix length and 12 consecutive sub-carriers (180 kHz) in the frequency domain. A RB may carry data for the WTRU 102a as well as for one or more other WTRUs. Also, in such an instance, the precoder W(n) may not only be a function of the airlink, channel H, the airlink between the eNB 140a and WTRU 102a, but also a function of the airlink between the eNB 140a and other WTRUs co-scheduled with WTRU 102a.

In some approaches to OFDM-MIMO, a precoder W(n) may be used. Further, in some approaches to OFDM-MIMO, such as the approach described in LTE-Advanced (LTE-A)/LTE Release 10, WTRU 102a may not have the knowledge of the precoder function W(n). In an example where the eNB 140a and the WTRU 102a may implement such an approach, the eNB 140a and WTRU 102a may include certain features. For example, the eNB 140 may transmit data on an RB over consecutive TTI's to any WTRU in the system, including but not limited to WTRU 102a. The WTRU 102a may then make estimation over consecutive TTI's from DM-RS on the RB to obtain effective channel estimates, and store the effective channel estimates into memory. Also, WTRU 102a may make an estimation based on the RB transmitted to other WTRUs. The eNB 140a may choose (either periodically, or triggered by certain events) to broadcast the precoding related information for N TTIs. An example event may be when the eNB 140a detects a sufficiently large number of WTRUs located in a high signal to noise ratio (SNR) region or area. In such instances, high accuracy of CSI feedback may be desired. When the precoding related information (or precoders, or precoding indexes) are broadcast, a common control channel may be added to the downlink, to which all WTRUs 102a, 102b, 102c have access.

In some instances, the eNB 140 may transmit an RB consisting of no user data. Within such RB, the eNB 140 may choose to transmit DM-RS precoded according to predetermined precoder so that no precoding information is needed to be broadcasted. During normal transmission where user data is transmitted on an RB, there may be a preferred transmission precoder to be used so that the data transmission may be optimized. For proper data reception, the same precoder may be applied to DM-RS on the same RB. However, when no data is present, one may use any precoder for DM-RS. For convenience, one may predefine a set of precoders for use in such cases. An example of a predetermined precoder is a subset of column vectors of an identity matrix.

The eNB 140a may also choose to indicate an invalid TTI. An invalid TTI may be a TTI that does not contain a valid DM-RS. This may be due to a mismatch between the eNB 140a and WTRU 102a, WTRU 102b, WTRU 102c being on different standard releases. The WTRU 102a may not include the invalid TTI in the channel estimation based on DM-RS. Upon receiving information of precoder W(n), along with the channel estimate made in the past TTIs, the WTRU 102a may be able to estimate the unprecoded channel. Various channel estimation algorithms may be used, such as least square (LS) or linear minimum mean square error (LMMSE). The precoder may be selected from a predetermined codebook, therefore only the index to the entry of codebook (e.g., TPMI) needs to be sent by broadcast or unicast from the eNB 140a. Alternatively, the precoder may be quantized element-wise first, then sent from the eNB 140a. In another option, the non-codebook based precoder may be first quantized into a predetermined codebook and its index may then be sent. At the WTRU 102a, the quantized precoder may then be treated as if it were used in an actual data transmission.

In addition or as an alternative to the approaches described above, the WTRU 102a may use DM-RS alone to generate CSI. This may be performed at the WTRU 102a as follows. The WTRU 102a may first determine the effective channel estimate from DM-RS using, for example, least mean square (LMS) approach. The effective channel may be shown below in Equation (1). In Equation (1), for the resource blocks (RBs) of interest, W(n) represents the precoding matrix at nth TTI. Hₘ(n) represents the vector channel to the mth antenna of the WTRU 102a, and h_{θ,m}(n) represents the effective channel measured by the WTRU 102a from DM-RS.

h_{θ,m}(n)=W^{T}(n)Hₘ^{T}(n)+z(n) Equation (1)

In a slow varying channel, it may be assumed that the channel remains constant for a certain period, i.e.: Hₘ(1)=Hₘ(2)= . . . =Hₘ

The system model becomes:

H̅_{θ,m}= W̅Hₘ^{T}+Z Equation (2)

where
H̅_{θ,m}(h_{θ,m}(1) . . . h_{θ,m}(N))^{T}
   and
W̅=W(1) . . . W(N))^{T}

A minimal mean square error estimate (MMSE) of the unprecoded channel becomes:

Ĥₘ^{T}= W̅^{H}( W̅W̅^{H}+σₙ²I)⁻¹ H̅_{θ,m} Equation (3)

The process continues for each receive antenna m, and the whole matrix channel (unprecoded) may be estimated. Based on this estimated channel matrix, proper feedback may be derived and fed back.

The channel estimation formula in Equation (3) may be extended to cases where the channel may not be constant during the time duration of interest. Assuming the WTRU 102a may have knowledge of effective channels and the precoder for TTI numbers from 1 to N, and the WTRU 102a may estimate the channel for TTI n, then

Ĥₘ^{T}(n)=E[Hₘ^{T}(n) H̅_{θ,m}^{H}](E[ H̅_{θ,m} H̅_{θ,m}^{H}])⁻¹ H̅_{θ,m} Equation (4)

The Equation (4) may also be extended to cross multiple resource blocks, and the second order statistics may be calculated based on Doppler frequency and channel delay profile.

In an attempt to make use of all reference symbols available in the operations in Equations (3) and (4), the DM-RS may be combined with the CSI-RS.

Equations (3) and (4) may be physically implemented at the eNB 140, WTRU 102a or both. In a first embodiment, WTRU 102a may measure effective channel based on DM-RS, receive precoding matrix information W(n), and perform Equations (3) and (4) to obtain unprecoded channel estimate. Based on unprecoded channel estimate, the WTRU 102a may generate CSI feedback to the eNB 140a, which in turn may generate transmit the precoding matrix for subsequent data transmission. In a second embodiment, WTRU 102a may first quantize the effective channel estimate and feeds it back to eNB 140a. Since the eNB has all information regarding the previous precoding matrices, it may perform the operations in Equations (3) and (4) to obtain unprecoded channel, and derive proper a precoding matrix for subsequent transmission accordingly.

The eNB 140a may broadcast scheduling information (e.g., the number of WTRUs scheduled in the resource block). The eNB 140a may use a simple bit map to indicate that there is at least one WTRU 102a transmitted on the resource block or none.

The eNB 140a may designate a sub-band for which DM-RS based CSI is fed back. Such a sub-band may be scheduled to a WTRU 102a that likely requires high accuracy CSI at the eNB 140a (e.g., the WTRUs that are likely to be in MU-MIMO mode, or in coordinated multi-point transmission and reception (CoMP) operation). Only the precoding related information and scheduling information of such a designated sub-band may be broadcast to reduce overall overhead.

The eNB 140a may also designate one or several sub-bands on which the transmission may be limited to rank M for certain period of time. The value of M may then be sent to WTRU 102a, 102b, 102c via high level signaling. While reporting DM-RS feedback, the WTRU 102a, 102b, 102c may be transmitted on the sub-band (s) on the corresponding M DM-RS antenna ports.

The eNB 140a may choose not to broadcast certain information, such as rank, scheduling information, or ScID, and instead rely on the WTRU 102a to retrieve the information via blind detection.

When the eNB 140a broadcasts precoder related information, the WTRU 102a may monitor and measure an effective channel from DM-RS, even though the WTRU 102a may not be the intended recipient of the resource blocks where the DM-RS is located. If some information, such as rank, scheduling or ScID is not signaled to the WTRU 102a, the WTRU 102a may perform blind detection to determine such parameters. The WTRU 102a may perform channel estimation on all DM-RS ports to obtain the precoded downlink channel (or effective channel). The WTRU 102a may perform channel estimation on the first M DM-RS ports to obtain the precoded downlink channel (or effective channel). By way of example, the value for M may be equal to 1. The WTRU 102a may make consecutive estimations on the resource block, and store the measured effective channel estimates into memory.

Upon receiving broadcasted precoding matrices, along with the channel estimate made in the past TTIs, the WTRU 102a may be able to estimate the nonprecoded channel. Various channel estimation algorithms may be used. Based on the estimated channel matrix, proper feedback may be derived and fed back.

The eNB 140a may send the precoder information to WTRU 102a, 102b, 102c, either via broadcast or unicast, therefore, increasing downlink channel overhead. In certain circumstances, it may be preferred to eliminate the need to send precoding matrix information from the eNB 140a. Under such circumstances, eNB 140a may request the WTRU 102a, 102b, 102c to feedback the quantized effective channel estimate, which is measured from DM-RS. Since the eNB 140a already has information of past precoding matrices, it may calculate the unprecoded channel estimate based on Equations (3) or (4).

Another approach to calculate unprecoded channel estimates at the eNB 140a other than Equations (3) or (4) may be a recursive approach similar to the least mean square (LMS) algorithm, which is outlined below. In this instance, the WTRU 102a may measure the effective channel from the DM-RS and feedback the quantized effective channel estimate to the eNB 140a. The eNB 140a may then reconstruct non-precoded CSI and use the feedback information for downlink scheduling with respect to WTRU 102a selection and proper precoding matrices.

There may be a pre-agreement between the eNB 140a and WTRU 102a that the DM-RS may be non-precoded. In this case the WTRU 102a may make use of the non-precoded DM-RS along with the CSI-RS to estimate non-precoded state information. A non-precoded DM-RS may be either due to the eNB 140a having other purposes such as interleaving or the WTRU 102a may request a non-precoded DM-RS such as for a joint RB channel estimate for the control channel, or that no user data may be carried on the RB. The non-precoded CSI may be quantized for feedback. Compared with channel estimation with only sparse CSI-RS, there may be more DM-RS symbols available to obtain more accurate channel estimates. Since data may still be precoded, the effective channel may be derived from the WTRU 102a with the help of the available broadcast precoding matrix. The WTRU 102a may also choose to feedback the quantized effective channel estimate to eNB 140b, 140c, or 140d for precoding. This may be done in view of a pre-agreement with the eNB 140a.

In the recursive approach, it may be assumed at time instant n, the eNB 140a has the current channel knowledge, Hₘ(n), corresponding to the channel between the mth receive antenna to transmit antennas. Also assume the precoding matrix used by the eNB 140a transmitter to be W(n). The eNB 140a may then calculate its own version of the effective channel

H_{m,θ}_{_{NB}}(n)=Hₘ(n)W(n) Equation (5)

Upon receiving the precoded DM-RS, the WTRU 102a may make channel estimations based on DM-RS, quantize the channel estimate, and feedback to the eNB 140a. Let the DM-RS feedback be, H_{m,θ}_{_{UE}}(n), the eNB 140a may then update its CSI information upon receiving the feedback:

Hₘ(n+1)=Hₘ(n)+μW^{H}(n)(H_{m,θ}_{_{UE}}(n)−H_{m,θ}_{_{NB}}(n))⁻ Equation (6)

After updating the CSI corresponding to WTRU 102a, 102b, 102c receive antennas, the eNB 140a may derive proper precoding matrix based certain criteria.

The aforementioned method may also be extended to combine both DM-RS and CSI-RS in order to provide better performance. If proper care is taken in identifying the precoder associated with CSI-RS with respect to the precoding matrices, both Equations (3) and (4) may be still applicable. The precoding matrix corresponding to CSI-RS from the kth transmit antenna is a column vector with its kth element equal to 1, and other elements equal to 0.

The channel estimation accuracy described above relies on the property of the aggregated precoding matrix defined in Equation (3). A necessary condition is that the rank of this matrix may be no less than the number of eNB 140a antennas. To reduce overhead, it may be preferred for an eNB 140a to check the property of this matrix, and only send it to WTRU 102a, when the rank condition is met. Similarly, it may be preferred for the eNB 140a to request WTRU 102a feedback only when the precoding matrices to be used may constitute an aggregated precoding matrix with a rank no less than the number of eNB 140a transmit antennas.

There may be several options for WTRU 102a feedback. For example, the WTRU 102a may feedback the quantized precoded downlink channel (or effective channel) on the physical uplink control channel (PUCCH) or the physical uplink shared channel (PUSCH) to the eNB 140a. Alternatively, in order to save uplink overhead, an uplink sounding reference signal (SRS) may be modulated with an un-quantized precoded downlink channel (or effective channel). The WTRU 102a uplink SRS transmission may alternate between unmodulated SRS and modulated SRS.

The WTRU 102a may feedback an effective channel across the whole system bandwidth, and may be directed by the network only to feedback the effective channel on a subband. The network may designate a subband for the WTRU 102a that requires high accuracy of CSI at eNB 140a transmitter.

The WTRU 102a may feedback an effective channel on all M antenna ports that carries data transmission. M may be signaled by the eNB 140a or detected by the WTRU 102a via blind detection. Alternatively, WTRU 102a may choose to feedback a subset of the effective channel, for example, on antenna port 7. Signaling of M may be done at a slower frequency via higher layer signaling, or at fast frequency via downlink control channel.

When the WTRU 102a sends feedback for the effective channel, the eNB 140a may need to retrieve channel information from effective channels with the knowledge of TPMI. Since the eNB 140a already has information of past precoding matrices, it may reconstruct the unprecoded channel based on feedback of the effective channel. Various channel reconstruction methods may be used, such as those described in Equations (3) and (4) above.

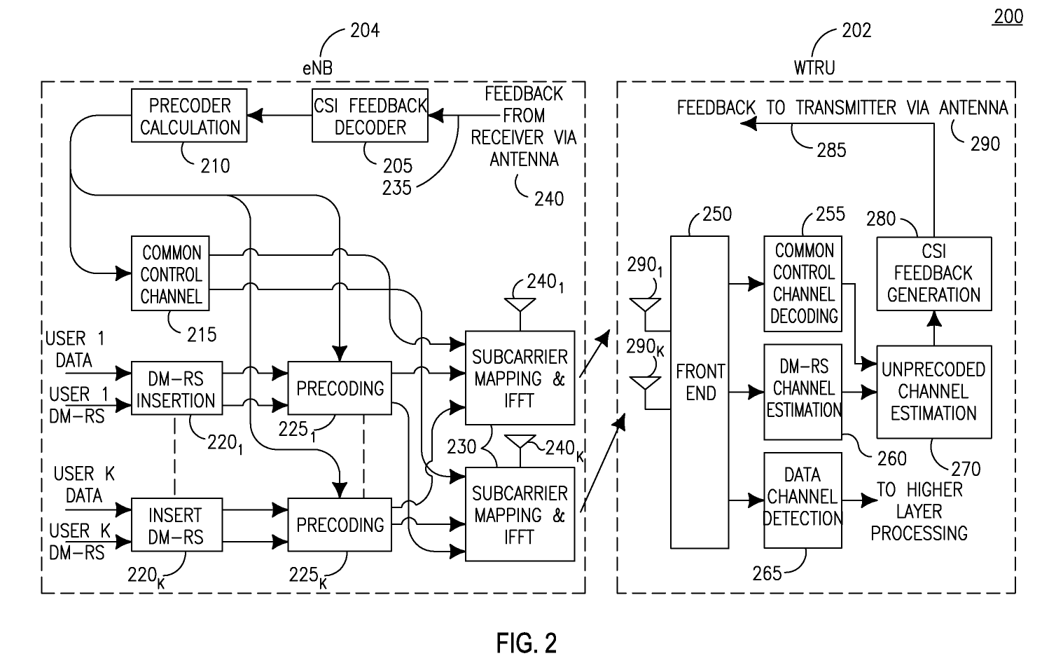

FIG. 2 is an example of the CSI feedback method and apparatus 200 based on an unprecoded channel. The eNB 204 may include a CSI feedback decoder unit 205, a precoder calculation unit 210, a common control channel 215, DM-RS insertion units 220, precoding units 225, subcarrier mapping and an inverse fast Fourier transfer units 230 and antennas 240. The WTRU 202 may include antennas 290, a front end unit 250, a common control channel decoding unit 255, a DM-RS channel estimation unit 260, a data channel detection unit 265, an unprecoded channel estimation unit 270, and a CSI feedback generation unit 280.

In FIG. 2, the eNB 204 may receive CSI feedback 285,235 from the WTRU 202, (although there is one shown in FIG. 2, there may be multiple WTRUs 202 via antennas 290 and eNBs antennas 240, decode the CSI feedback 205 and based on the CSI, calculate the proper precoding matrix 210. The precoding matrix may be forwarded to the common control channel 215 for decoding by all users in the cell and to each of the precoding units 225. Each precoding unit 225 may apply the precoding matrix to an output of the corresponding DM-RS insertion unit 220, where each DM-RS insertion unit output is based on corresponding user data and user DM-RS for all scheduled users in the next transmission. The output of each precoding unit 225 may be forwarded to each subcarrier mapping and IFFT unit 230, the output of which is transmitted by a corresponding antenna 240.

The WTRU 202 may obtain the effective channel estimate via the DM-RS channel estimation unit 260 from data received through the antennas 290 and the front end 250. The DM-RS may be intended for any user, therefore the DM-RS may not be limited to the WTRU 202 currently performing channel estimation.

The WTRU 202 may derive an estimate of the unprecoded channel 270 from the DM-RS estimation unit 260 and precoder information decoded in the common control channel decoding unit 255, and generate CSI feedback 280 based on unprecoded channel. The CSI feedback 280 may be transmitted back to the eNB 204 through antennas 290.

The data channel detection unit 265 is identified in FIG. 2 to show that DM-RS may not incur additional downlink overhead. However, the DM-RS may be used for data modulation anyway. The RB may be intended for WTRU 202, then the data channel detection exists in WTRU 202; however, if the RB is not intended for WTRU 202, the data channel detection may exist somewhere else. The output of channel detection unit 265 may be forwarded to higher layer processing, and eventually the application processor of the intended WTRU 202.

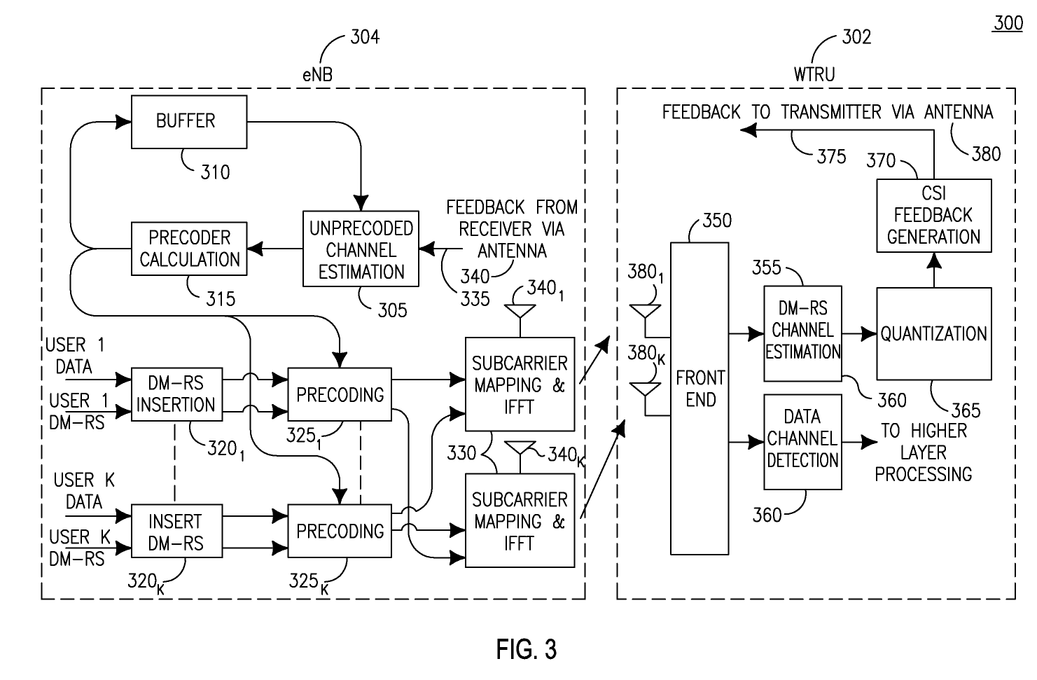

FIG. 3 is an example method and apparatus 300 to feedback an effective channel. The eNB 304 may include a unprecoded channel estimation unit 305, a precoder calculation unit 315, a buffer 310, DM-RS insertion units 320, precoding units 325, subcarrier mapping and an inverse fast Fourier transfer units 330 and antennas 340. The WTRU 302 may include antennas 380, a front end unit 350, a DM-RS channel estimation unit 355, a data channel detection unit 360, a quantization unit 365, and a CSI feedback generation unit 370.

In FIG. 3, the eNB 304 may receive CSI feedback 375,335 regarding the effective channel from the WTRU 302 via antennas 380 and eNB antennas 340, and combine the information of the previous precoder from a buffer 310 in the unprecoded channel estimation unit 305 to obtain a channel estimate. The precoder calculation unit 315 may derive the proper precoder information for future data and DM-RS transmissions from the channel estimate output of the unprecoded channel estimation unit 305, and store the precoder information in a buffer 310. Each precoding unit 325 may apply the precoder information to an output of the corresponding DM-RS insertion unit 320, where each DM-RS insertion unit output is based on corresponding user data and user DM-RS for all scheduled users in the next transmission. The output of each precoding unit 325 may be forwarded to each subcarrier mapping and IFFT unit 330, the output of which is transmitted by a corresponding antenna 340.

The WTRU 302 may obtain the effective channel via the DM-RS channel estimation unit 355 from data received through the antennas 380 and the front end 350. The estimated DM-RS signals may be quantized by quantization unit 365 and sent to the CSI feedback generation unit 370. The CSI feedback 375 may be transmitted back to the eNB 304 through antennas 380 and 340. The WTRU 302 may also obtain the user data via the data channel detection unit 360 from data received through the antennas 380 and the front end 350. The detected user data may then be forwarded to higher layers.

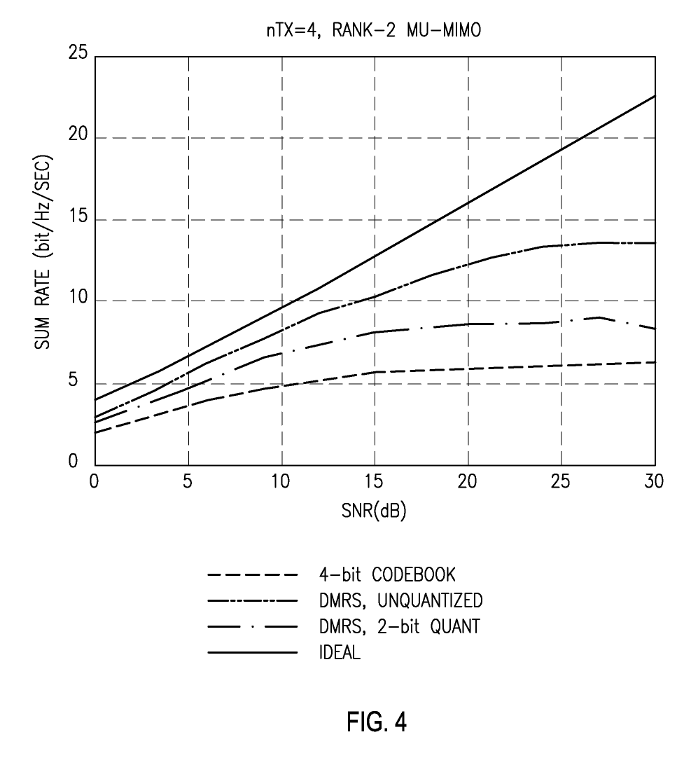

FIG. 4 is an example of the performance comparison between the proposed scheme and existing schemes. In a multi-user multiple input multiple output (MU-MIMO) system. There are 20 WTRUs in the cell to be scheduled to a certain resource block. The 20 WTRUs are grouped into 10 pairs randomly. The RB of interest is assigned to the 10 pairs in a round robin fashion. The eNB is equipped with 4 antennas, and each WTRU has a single antenna. In the conventional embodiment, each WTRU feeds back a 4 bit precoding matrix index (PMI) for each TTI (assume a CSI-RS is available for each TTI); in the proposed embodiment, each WTRU feeds back the quantized effective channel estimate with 2 bits. FIG. 4 shows the results. Noticeably, the proposed embodiment performs better with less feedback overhead even if there is a CSI-RS available for the WTRU to generate a PMI. In practical LTE-A systems, the CSI-RS may not be available at each TTI, so the performance gap may be greater than shown.

Although examples are provided above with reference to LTE Release 10, the principles described above may be used in the context of other wireless technologies, including but not limited to technologies based on LTE Release 11, IEEE 802.16m, any technology that includes the use of OFDM and/or MIMO, and/or any other appropriate technology.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU) comprising:
at least one antenna; and
a processor, operatively coupled to the antenna, configured to receive from an eNodeB information designating at least one sub-band; wherein the designated sub-band includes a demodulation reference signal (DM-RS) for use by a plurality of WTRUs; wherein non-designated sub-bands do not include a DM-RS; and
wherein the processor is further configured to utilize at least one DM-RS to estimate a channel of the designated sub-band.

2. The WTRU of claim 1 wherein the processor is further configured to receive a scrambling indication associated with the DM-RS.

3. The WTRU of claim 1 wherein a plurality of DM-RSs are used to estimate a channel for a plurality of antenna ports of the eNodeB.

4. The WTRU of claim 1 wherein the processor is further configured to receive a channel state information reference signal (CSI-RS) and to estimate a channel using the CSI-RS.

5. The WTRU of claim 1 wherein the plurality of DM-RSs were transmitted using a plurality of antenna ports and were not precoded.

6. A method comprising:
receiving, by a wireless transmit/receive unit (WTRU), information designating at least one sub-band; wherein the designated sub-band includes a demodulation reference signal (DM-RS) for use by a plurality of WTRUs; wherein non-designated sub-bands do not include a DM-RS; and
utilizing, by the WTRU, at least one DM-RS to estimate a channel of the designated sub-band.

7. The method of claim 6 further comprising receiving, by the WTRU, a scrambling indication associated with the DM-RS.

8. The method of claim 6 wherein a plurality of DM-RSs are used to estimate a channel for a plurality of antenna ports of an eNodeB.

9. The method of claim 6 further comprising receiving a channel state information reference signal (CSI-RS) and to estimate a channel using the CSI-RS.

10. The method of claim 6 wherein the plurality of DM-RSs were transmitted using a plurality of antenna ports by an eNodeB and were not precoded.

11. An eNodeB comprising:
at least one antenna port; and
a processor, operatively coupled to the antenna port, configured to transmit to each of a plurality of wireless transmit/receive units (WTRUs) information designating at least one sub-band;
wherein the processor is further configured to transmit a demodulation reference signal (DM-RS) in the designated at least one sub-band for use by the plurality of WTRUs to estimate a channel of the at least one sub-band; and wherein non-designated sub-bands do not include a DM-RS.

12. The eNodeB of claim 11 wherein the processor is further configured to transmit a scrambling indication associated with the DM-RS.

13. The eNodeB of claim 11 wherein a plurality of DM-RSs are transmitted over a plurality of antenna ports of the eNodeB.

14. The eNodeB of claim 11 wherein the processor is further configured to transmit a channel state information reference signal (CSI-RS) to the plurality of WTRUs.

15. The eNodeB of claim 11 wherein a plurality of DM-RSs are transmitted using a plurality of antenna ports and are not precoded.
